(19) United States
(12) Patent Application Publication
(10) Pub. No.: US 2026/0004547 A1
(43) Pub. Date: Jan. 1, 2026

(54) INFORMATION PROCESSING APPARATUS, IMAGE CAPTURING APPARATUS, INFORMATION PROCESSING METHOD, AND STORAGE MEDIUM

(71) Applicant: CANON KABUSHIKI KAISHA, Tokyo (JP)

(72) Inventor: TOMOKI TAMINATO, Kanagawa (JP)

(21) Appl. No.: 19/243,324

(22) Filed: Jun. 19, 2025

(30) Foreign Application Priority Data
Jun. 26, 2024 (JP) 2024-102814

(51) Int. Cl. G06V 10/26; G06T 7/246; G06T 7/55; G06V 10/25; G06V 10/75; H04N 23/67

(52) U.S. Cl. CPC G06V 10/26; G06T 7/248; G06T 7/55; G06V 10/25; G06V 10/759; H04N 23/67; G06T 2207/10016

(57) ABSTRACT

An information processing apparatus includes an acquisition unit configured to acquire images captured in time series and distance information in a depth direction on a plurality of areas in each of the images, a detection unit configured to detect a candidate area of an object to be a tracking target from each of the images based on an image feature of each of the images, an estimation unit configured to estimate an occlusion state indicating whether the object to be the tracking target is occluded by another object different from the tracking target for the candidate area detected from each of the images based on time-series data of the distance information, and a determination unit configured to determine the candidate area of the object to be the tracking target from the candidate area detected from each of the images based on an estimation result of the occlusion state.

### BACKGROUND

### Technical Field

The present disclosure relates to a technique for tracking an object.

### Description of the Related Art

A technique for extracting a specific object image from images captured in time series and tracking an object is used to identify a face area or a body area of a person in a moving image. Examples of the techniques for tracking the specific object image in an image include techniques that use brightness and color information, template matching, and machine learning such as Deep Neural Network. “L. Bertinetto et al “Fully-Convolutional Siamese Networks for Object Tracking”, ECCV2016.” discusses a technique of inputting an image including a tracking target and an image in which the tracking target is to be searched for to respective convolutional neural networks with the same weight, and calculating correlation between obtained feature amounts to specify a position at which the tracking target is present in the image. Japanese Patent Application Laid-Open No. 2022-19339 discusses a technique of estimating an occlusion relationship between each object detected from an image and a different object and identifying a correspondence relationship with an object detected in an image captured at a time different from that of the image.

However, with the method discussed in “L.Bertinetto et al. “Fully-Convolutional Siamese Networks for Object Tracking”, ECCV2016.”, there may be cases where a similar object is erroneously identified as a tracking target in a case where a tracking target object and an object with a feature similar to that of the tracking target object are present near each other. Further, with the method discussed in Japanese Patent Application Laid-Open No. 2022-19339, there remains a possibility of making an erroneous estimation of an occlusion relationship with respect to the object with a similar feature.

### SUMMARY

The present disclosure is directed to a technique capable of tracking a tracking target object accurately.

According to an aspect of the present disclosure, an information processing apparatus includes at least one processor configured to function as an acquisition unit configured to acquire images captured in time series and distance information in a depth direction on a plurality of areas in each of the images, a detection unit configured to detect a candidate area of an object to be a tracking target from each of the images based on an image feature of each of the images, an estimation unit configured to estimate an occlusion state indicating whether the object to be the tracking target is occluded by another object different from the tracking target for the candidate area detected from each of the images based on time-series data of the distance information, and a determination unit configured to determine the candidate area of the object to be the tracking target from the candidate area detected from each of the images based on an estimation result of the occlusion state.

Further features of the present disclosure will become apparent from the following description of exemplary embodiments with reference to the attached drawings.

### BRIEF DESCRIPTION OF THE DRAWINGS

FIG. 1 is a block diagram illustrating an example of an entire configuration of an image capturing apparatus.

FIG. 2 is a diagram illustrating a defocus amount.

FIG. 3 is a block diagram illustrating a functional configuration of the image capturing apparatus according to a first exemplary embodiment.

FIG. 4 is a block diagram illustrating a configuration of a first estimation unit.

FIG. 5 is a flowchart illustrating tracking processing according to the first exemplary embodiment.

FIG. 6 is a flowchart illustrating first occlusion state estimation processing.

FIGS. 7A, 7B, 7C, and 7D are diagrams illustrating a scene in which a tracking target object moves near another object.

FIG. 8 is a flowchart illustrating first occlusion determination processing.

FIGS. 9A, 9B, 9C, and 9D are diagrams illustrating a scene in which a tracking target object moves near another object.

FIG. 10 is a block diagram illustrating a functional configuration of an image capturing apparatus according to a second exemplary embodiment.

FIG. 11 is a flowchart illustrating tracking processing according to the second exemplary embodiment.

FIG. 12 is a flowchart illustrating second occlusion state estimation processing.

FIGS. 13A, 13B, 13C, and 13D are diagrams illustrating a scene in which a tracking target object moves near another object.

FIG. 14 is a flowchart illustrating second occlusion determination processing.

FIG. 15 is a graph illustrating a time-series shift of a position of a focus lens in the image capturing apparatus.

### DESCRIPTION OF THE EMBODIMENTS

Hereinafter, exemplary embodiments will be described in detail with reference to the accompanying drawings. The following exemplary embodiments do not limit the disclosure according to the scope of the claims. Although a plurality of configurations is described in the exemplary embodiments, not all of the plurality of configurations are necessarily essential to the disclosure, and the plurality of configurations may be freely combined. Furthermore, in the accompanying drawings, the same reference numerals are given to the same or similar configurations, and redundant description thereof will be omitted.

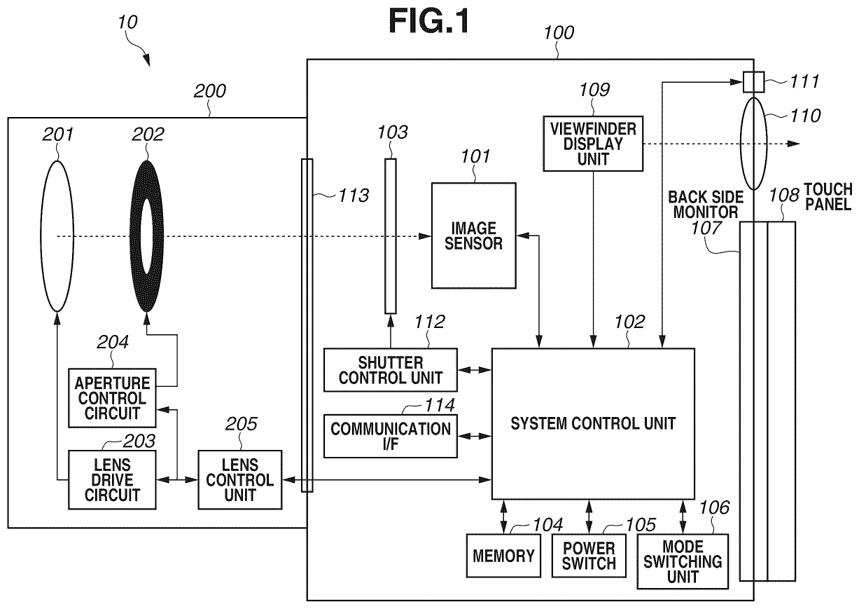

FIG. 1 illustrates an example of a hardware configuration of an image capturing apparatus including an information processing apparatus according to a first exemplary embodiment.

In FIG. 1, an image capturing apparatus 10 is a lens-interchangeable type digital camera. The image capturing apparatus 10 may be a pan/tilt/zoom (PTZ) camera, a mobile phone (smartphone), or a personal computer (PC), as long as the image capturing apparatus 10 is an electronic apparatus having an image capturing function. In the present exemplary embodiment, the information processing apparatus is configured integrally with the image capturing apparatus 10, but may be configured with a PC or the like externally connected to the image capturing apparatus 10. In such a case, the information processing apparatus acquires a captured image and information obtained at an image capturing time from the image capturing apparatus 10 to perform various kinds of processing.

As illustrated in FIG. 1, the image capturing apparatus 10 according to the present exemplary embodiment includes a camera body 100 and a lens unit 200 that guides incident light to an image sensor 101.

First, the camera body 100 will be described. The camera body 100 includes the image sensor 101, a system control unit 102, a shutter 103, a shutter control unit 112 for controlling the shutter 103, a memory 104, a power switch 105, a mode switching unit 106, and a communication interface (I/F) 114.

The image sensor 101 includes a complementary metal-oxide semiconductor (CMOS) type image sensor, and converts an optical signal, which is an optical image, into an electrical signal. The electrical signal is output to the system control unit 102 as an image signal after predetermined signal processing is performed thereon. The light that has entered an imaging lens 201 forms an optical image on an imaging plane on the image sensor 101 through an aperture 202 and the shutter 103.

The system control unit 102 includes a central processing unit (CPU) and the like, and is connected to a lens control unit 205 of the lens unit 200 to control the entire image capturing apparatus 10. The system control unit 102 includes an image processing unit for processing the image signal output from the image sensor 101. The system control unit 102 further includes a phase difference autofocus (AF) unit that performs focus detection processing using a phase difference AF method, based on focus detection image data (signal for phase difference AF) obtained via the image sensor 101 and the image processing unit. More specifically, the image processing unit generates a pair of image data formed by light fluxes that have passed through a pair of pupil areas of an imaging optical system as the focus detection image data (first focus detection signal and second focus detection signal). The phase difference AF unit detects a defocus amount based on a shift amount between the pair of image data. In this way, the phase difference AF unit according to the present exemplary embodiment performs the phase difference AF (image plane phase difference AF) based on the outputs of the image sensor 101, without using a dedicated AF sensor.

The memory 104, the power switch 105, the mode switching unit 106, and the communication I/F 114 are connected to the system control unit 102. The memory 104 includes a volatile memory, a nonvolatile memory, and the like. The nonvolatile memory in the memory 104 stores programs for operation of the system control unit 102, variables of various kinds of parameters, constants, and the like. The volatile memory in the memory 104 temporarily stores setting values of various kinds of parameters of an International Organization for Standardization (ISO) sensitivity and the like. Further, the volatile memory in the memory 104 stores, in time series, the predetermined number of frames of images captured by the image sensor 101, and depth information of the images. Details of the depth information will be described below.

The power switch 105 is a switch for switching the power ON and OFF of the camera body 100. The mode switching unit 106 is a switch for switching between various image capturing modes such as a live view image capturing mode and a moving image capturing mode. The communication I/F 114 is an interface for connecting to an external apparatus via a wired or a wireless communication path. The system control unit 102 transmits captured images and information at the image capturing time to an external apparatus, and receives control signals and various kinds of setting information, via the communication I/F 114.

The camera body 100 is mounted with aback side monitor 107 and a touch panel 108. The back side monitor 107 and the touch panel 108 are connected to the system control unit 102. The back side monitor 107 is an example of a display unit, and includes a liquid crystal device or light-emitting diodes (LEDs). The back side monitor 107 displays an image (live view image) that is being captured by the image sensor 101 and image capturing information such as characters, graphics, and icons indicating various kinds of information, through the control of the system control unit 102. The system control unit 102 may display rectangular frames corresponding to areas of a tracking target object and another object on the live view image in a superimposed manner. The touch panel 108 is an example of an operation unit, and receives a user operation. The touch panel 108 is arranged in an area substantially the same as an area of the back side monitor 107, and detects a contact by a finger (fingers) of a user or a pen, and notifies the system control unit 102 of a contact position on the back side monitor 107. The system control unit 102 performs processing associated with the contact position based on the contact position on the touch panel 108.

Further, the camera body 100 is mounted with an electronic viewfinder (EVF). The EVF includes a viewfinder display unit 109 and an eyepiece lens 110. Similar to the back side monitor 107, the viewfinder display unit 109 displays a live view image and various kinds of image capturing information through the control by the system control unit 102. An eye-proximity detection unit 111 detects a user's eye proximity state. The system control unit 102 switches a display destination of the image capturing information described above between the back side monitor 107 and the viewfinder display unit 109 depending on a detection result of the eye-proximity detection unit 111.

Next, a configuration of the lens unit 200 will be described. The camera body 100 and the lens unit 200 are mechanically and electrically connected via a lens mount mechanism 113 and are attachable to and detachable from each other. The lens unit 200 includes the imaging lens 201, the aperture 202, a lens drive circuit 203, an aperture control circuit 204, and the lens control unit 205. FIG. 1 illustrates only one imaging lens 201 for simplification, but actually, the imaging lens 201 includes a plurality of imaging lens groups including a focus lens.

The lens control unit 205 controls the entire lens unit 200 through the control of the system control unit 102. The lens control unit 205 includes a memory (not illustrated) to store a program for the operation of the lens unit 200, setting values of various kinds of parameters, and individual information unique to each lens unit such as maximum and minimum aperture values and a focal length.

The system control unit 102 of the camera body 100 calculates a defocus amount using information output from the image sensor 101. Then, the system control unit 102 controls the lens drive circuit 203 through communication via the lens control unit 205 of the lens unit 200 to perform focusing based on the calculated defocus amount. The lens control unit 205 acquires lens drive information about a driving amount of the imaging lens 201 in a focus lens optical axis direction, and outputs the lens drive information to the system control unit 102.

### <Relationship Between Defocus Amount and Image Shift Amount>

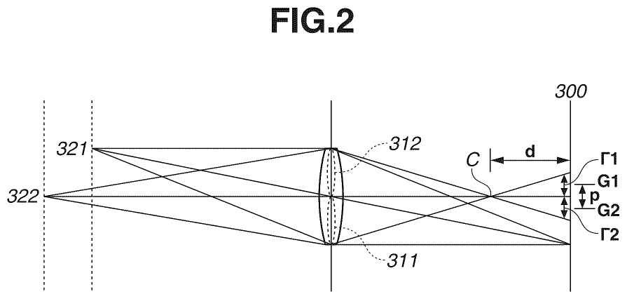

With reference to FIG. 2, a description is provided of a relationship between the defocus amount and the image shift amount (phase difference) based on the first focus detection signal and the second focus detection signal output from the image sensor 101.

The image sensor 101 is arranged on an imaging plane 300 in FIG. 2, and an exit pupil of the imaging optical system is divided into two areas, i.e., a first exit pupil area 311 and a second exit pupil area 312. When a magnitude from an image-forming position C of the light fluxes from an object to the imaging plane 300 is defined as |d|, a front-focused state of a defocus amount d where the image-forming position C of the object is located on the object side of the imaging plane 300 is defined as a positive sign (d>0) side. Further, a back-focused state where the image-forming position C of the object is located on the opposite side of the object with respect to the imaging plane 300 is defined as a negative sign (d<0) side. Further, in an in-focus state where the image-forming position C of the object is on the imaging plane 300 (i.e., in-focus state), d=0. FIG. 2 illustrates an example in which an object 321 is in the in-focus state (d=0), and an object 322 is in the front-focused state (d>0). The front-focused state (d>0) and the back-focused state (d<0) are integrally referred to as a defocus state (|d|>0).

In the front-focused state (d>0), from among the light fluxes from the object 322, the light flux passing through the first exit pupil area 311 (second exit pupil area 312) is once condensed and then is spread by a width Γ1 (Γ2) with a centroid position G1 (G2) of the light flux as the center, and forms a defocused image on the imaging plane 300. The defocused image is received by a first focus detection pixel (second focus detection pixel) on the imaging plane 300 of the image sensor 101, and a first focus detection signal (second focus detection signal) is generated. In other words, the first focus detection signal (second focus detection signal) is a signal expressing an object image in which the object 322 is defocused by the defocus width Γ1 (Γ2) at the centroid position G1 (G2) of the light flux on the imaging plane 300.

The defocus width Γ1 (Γ2) of the object image increases approximately in proportion to an increase of the magnitude |d| of the defocus amount d. Similarly, a magnitude |p| of an image shift amount p between the first focus detection signal and the second focus detection signal (=a difference between the centroid positions G1 and G2 of the light fluxes) also increases approximately in proportion to the increase of the magnitude |d| of the defocus amount d. In the back-focused state (d<0), although an image shift direction between the first focus detection signal and the second focus detection signal is opposite to that in the front-focused state, the relationship is similar.

As described above, the magnitude of the image shift amount between the first and second focus detection signals increases as the magnitude of the defocus amount increases. In the present exemplary embodiment, the phase difference AF unit performs a focus detection of an image plane phase difference detection system in which the defocus amount is calculated from the image shift amount between the first and second focus detection signals obtained using the image sensor 101.

Accordingly, the phase difference AF unit of the system control unit 102 converts the image shift amount into a detection defocus amount using a conversion coefficient calculated based on a base line length, based on a relationship in which the magnitude of the image shift amount between the first and second focus detection signals increases as the defocus amount increases. As a unit of the defocus amount in the present exemplary embodiment, [Fδ], which is a product of an aperture F value in the imaging optical system at an image capturing time and a permissible confusion circle diameter δ, is used.

Next, tracking processing according to the present exemplary embodiment will be described.

In the present exemplary embodiment, during the tracking processing, in a scene in which a tracking target object selected by the user in image capturing moves near a similar object, an occlusion state of the tracking target object is estimated using time-series data on depth information based on the defocus amount. The occlusion state indicates whether the tracking target object is occluded by another object. Hereinbelow, for ease of explanation, it is assumed that the object is a person, but a range of application of the present exemplary embodiment is not limited to a person, and the present exemplary embodiment is applicable to a movable object such as an animal and a vehicle.

Hereinbelow, a description is given focusing on a scene in which an object similar to a tracking target object is present near the tracking target object, and they overlap each other.

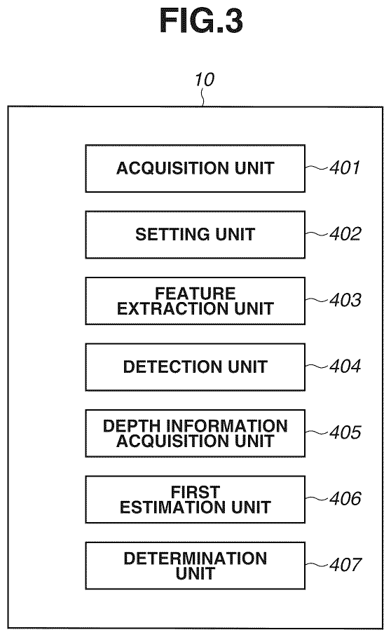

FIG. 3 illustrates an example of a functional configuration of the image capturing apparatus 10 according to the present exemplary embodiment. The image capturing apparatus 10 functions as an acquisition unit 401, a setting unit 402, a feature extraction unit 403, a detection unit 404, a depth information acquisition unit 405, a first estimation unit 406, and a determination unit 407 by the system control unit 102 executing a program stored in the memory 104.

The acquisition unit 401 acquires images captured by the image sensor 101 in time series. At this time, the acquisition unit 401 sequentially acquires frames of a moving image captured by the image capturing apparatus 10.

The setting unit 402 sets a tracking target object by a user input. For example, when the user touches the touch panel 108 with regard to an image that is being captured and displayed on the back side monitor 107, the setting unit 402 detects an object area nearest to a touched position, and sets the object area as a tracking target. In detecting the object area, for example, a machine learning model trained by a publicly known technique is used. In a case where the machine learning model is used, the setting unit 402 applies the machine learning model to the captured image to detect a person area on the image as the object area.

The feature extraction unit 403 extracts an image feature of the tracking target object area set by the setting unit 402. The image feature may be, for example, a template image of the tracking target object area, or an image feature extracted by a calculation performed by a machine learning model trained for the tracking target object area, as described in “L.Bertinetto et al “Fully-Convolutional Siamese Networks for Object Tracking”, ECCV2016”. The extracted image feature is stored in the memory 104.

From the images acquired by the acquisition unit 401, the detection unit 404 detects an area having an image feature similar to the image feature extracted by the feature extraction unit 403 as a candidate area for an object candidate to be a tracking target. The detection unit 404 performs a correlation calculation between the image feature of the tracking target extracted by the feature extraction unit 403 and the image feature extracted from the image to detect an area with a matching cost lower than a threshold value as the object candidate as described, for example, in “L.Bertinetto et al. “Fully-Convolutional Siamese Networks for Object Tracking”, ECCV2016”. When the image feature is expressed with an n-dimensional feature vector, the matching cost is given, for example, as an L1 distance between feature vectors of the image features, and the smaller the L1 distance is, the more similar the image features are. In this way, the tracking target can be identified by searching for an area with the minimum matching cost.

The depth information acquisition unit 405 acquires depth information representing a defocus amount detected in each focus detection area on the imaging plane, corresponding to the images acquired in time series by the acquisition unit 401. In a case where the acquisition unit 401 acquires frames of the moving image, the depth information acquisition unit 405 acquires the depth information for each frame.

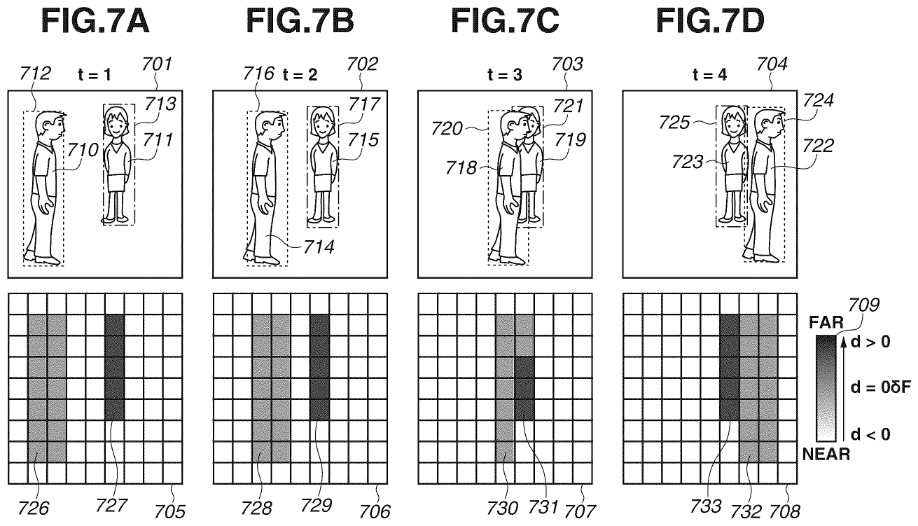

The depth information will be described below with reference to FIGS. 7A to 7D, and thus a description thereof is omitted here. The defocus amount is an example of distance information in the depth direction. The distance information in the depth direction is not limited to the defocus amount, and a depth map obtained by stereo matching processing between a plurality of images may be used.

The first estimation unit 406 estimates the occlusion state indicating whether the tracking target object is occluded by another object, using the depth information acquired by the depth information acquisition unit 405.

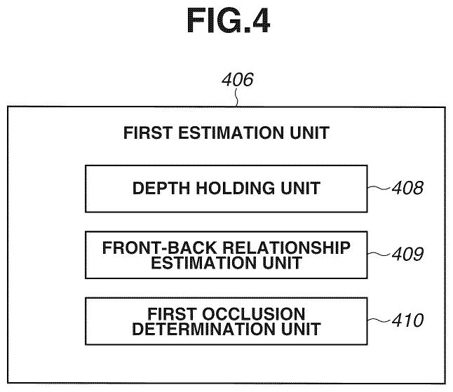

As illustrated in FIG. 4, the first estimation unit 406 includes a depth holding unit 408, a front-back relationship estimation unit 409, and a first occlusion determination unit 410.

The depth holding unit 408 holds, in time series, the depth information acquired by the depth information acquisition unit 405. For example, the depth holding unit 408 associates tracking information on the tracking target object in images corresponding to previous N frames and an object near the tracking target object with the depth information on each object area, and stores the associated information in the memory 104. The front-back relationship estimation unit 409 estimates a front-back relationship (i.e., whether the tracking target object is located in front of or behind another object) in the depth direction between the tracking target object and the object near the tracking target object, using the depth information for the previous N frames held by the depth holding unit 408. The first occlusion determination unit 410 determines the occlusion state of the tracking target object using the front-back relationships in the previous N frames estimated by the front-back relationship estimation unit 409.

The determination unit 407 determines the object to be the tracking target from among object candidates detected by the detection unit 404 based on an estimation result of the first estimation unit 406.

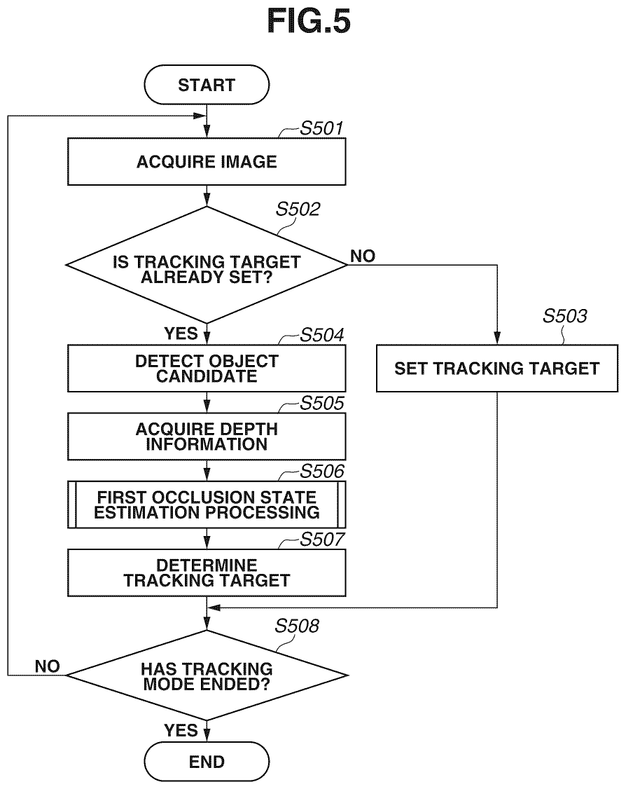

FIG. 5 is a flowchart illustrating the tracking processing performed by the image capturing apparatus 10 according to the present exemplary embodiment. The flowchart is implemented by the system control unit 102 executing a program stored in the memory 104 or the like. The flowchart starts when the mode is switched to a tracking mode by an instruction from the user.

In step S501, the acquisition unit 401 acquires an image captured by the image sensor 101. The back side monitor 107 displays the acquired image as a live view image. In the present exemplary embodiment, the acquisition unit 401 acquires frames of a moving image.

In step S502, the setting unit 402 determines whether a tracking target has already been set. In a case where the tracking target has already been set (YES in step S502), the processing proceeds to step S504. In a case where the tracking target has not been set (NO in step S502), the processing proceeds to step S503.

In step S503, the setting unit 402 detects an object area near a position designated on the touch panel 108 in the image displayed on the back side monitor 107, and sets the detected object area as the tracking target. The feature extraction unit 403 extracts an image feature of the detected object area. Then, the setting unit 402 stores the image feature or the like of the template of the tracking target object area on the image in the memory 104. In a case where the image captured by the image capturing apparatus 10 is delivered to an external apparatus, the object area to be set as the tracking target may be set based on operation information received from the external apparatus.

In step S504, the feature extraction unit 403 extracts an image feature from the image acquired in step S501. Then, the detection unit 404 detects an object candidate by reading the image feature of the tracking target from the memory 104 and performing matching of the extracted image feature of the image with the read image feature. In this way, an object area similar to the tracking target is detected as the object candidate. In the present exemplary embodiment, the detection unit 404 detects the object candidate for each frame.

In step S505, the depth information acquisition unit 405 acquires the depth information corresponding to the image acquired in step S501.

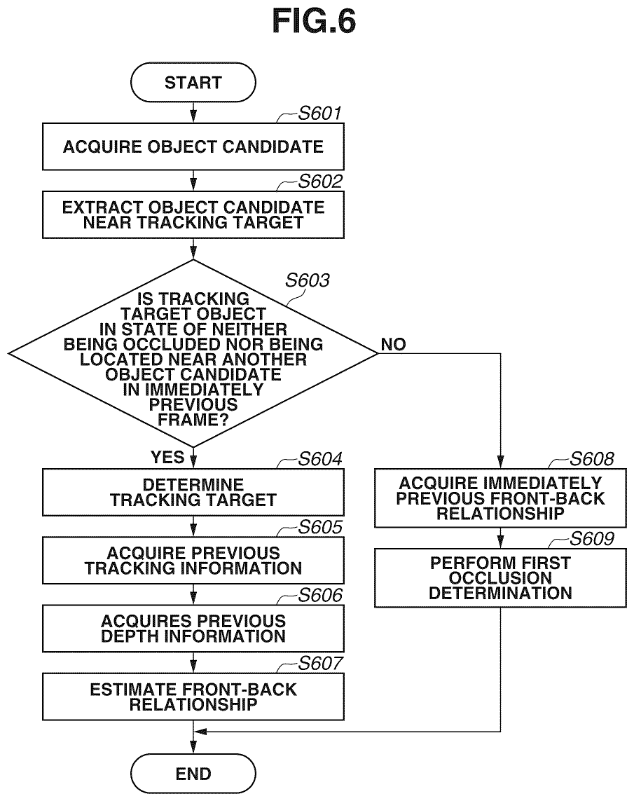

In step S506, the first estimation unit 406 estimates the occlusion state of the tracking target object. Details of first occlusion state estimation processing executed in step S505 will be described below with reference to FIGS. 6 to 8.

In step S507, the determination unit 407 determines the tracking target from among object candidates detected in step S504 based on the estimation result of the occlusion state of the tracking target in step S506.

In step S508, the system control unit 102 determines whether the tracking mode has ended. As long as the tracking mode continues (NO in step S508), the system control unit 102 returns the processing to step S501 to acquire an image.

In the present exemplary embodiment, the acquisition unit 401 sequentially acquires the frames of the moving image. In a case where the system control unit 102 determines that the tracking mode has ended (YES in step S508), the tracking processing illustrated in FIG. 5 ends.

FIG. 6 is a flowchart illustrating the first occlusion state estimation processing performed in step S506 in FIG. 5. FIGS. 7A to 7D illustrate an example of a scene in which the tracking target object moves near a similar object from left to right. The upper figures in FIGS. 7A to 7D illustrate consecutive frames. The lower figures in FIGS. 7A to 7D illustrate pieces of depth information corresponding to the respective frames illustrated in the upper figures. Assume that an object area 712 is set as the tracking target in an image 701 in FIG. 7A. First objects 710, 714, 718, and 722 are the objects of a same person detected as the object candidates in step S504. In this case, the first object is an object to be the tracking target. Second objects 711, 715, 719, and 723 are the objects of a same person detected as the object candidate in step S504.

In step S601, the first estimation unit 406 acquires an object candidate. For example, the first estimation unit 406 may directly acquire the object candidate detected in step S504 as the object candidate, or may acquire the object candidate by narrowing down object candidates to those within a certain distance from the centroid coordinates of the tracking target in the immediately previous frame.

In step S602, the first estimation unit 406 extracts the object candidate located near the tracking target from among the object candidates acquired in step S601. For example, the first estimation unit 406 extracts the object candidate overlapping the tracking target in the immediately previous frame. In an image 702 in FIG. 7B, the first estimation unit 406 may extract an object candidate 716 by determining that the object candidate 716 overlaps the first object 710 in the immediately previous frame, and may exclude an object candidate 717 by determining that the object candidate 717 does not overlap the first object 710 in the immediately previous frame.

As an example of an index for evaluating a degree of overlapping, Intersection over Union (IoU) is used. For example, the first estimation unit 406 calculates an IoU value between rectangular areas each surrounding an object, and in a case where the IoU value is 0.1 or more, the first estimation unit 406 determines that the areas overlap each other. The first estimation unit 406 may determine that the areas are in an overlapping state when at least portions thereof overlap, and a threshold value for the IoU value for determining that the areas are in the overlapping state may be appropriately adjusted.

In step S603, the first estimation unit 406 determines whether the tracking target object is in a state of neither being occluded nor being located near (being overlapped with) another object candidate in the immediately previous frame. In a case where the tracking target object is in the state of neither being occluded nor being overlapped with the other object candidate in the immediately previous frame (YES in step S603), the processing proceeds to step S604 and the subsequent steps on an assumption that there is no possibility that the tracking target object is occluded. Alternatively, for example, in a case where the first estimation unit 406 determines that the tracking target object is not being occluded in the immediately previous frame and the object candidates in a current frame do not overlap each other, the processing may proceed to step S604 and the subsequent steps. In other words, in the case where the tracking target object is not occluded in the immediately previous frame and the object candidates do not overlap each other in the immediately previous frame or the current frame, the first estimation unit 406 may advance the processing to step S604 and the subsequent steps.

In a case where the tracking target object is not occluded in the immediately previous frame and is located near (overlaps) the other object candidate (NO in step S603), the processing proceeds to step S608 and the subsequent steps. Further, for example, in a case where the first estimation unit 406 determines that the tracking target object is not occluded in the immediately previous frame and the object candidates in the current frame overlap each other, the processing may proceed to step S608 and the subsequent steps. In other words, in the case where the tracking target object is not occluded in the immediately previous frame and the object candidates overlap each other in the immediately previous frame or the current frame, the first estimation unit 406 may advance the processing to step S608 and the subsequent steps.

Further, in a case where the tracking target object is occluded in the immediately previous image, since there is a possibility that only the object candidate on the front side is detected and the degree of overlapping cannot be calculated, the first estimation unit 406 advances the processing to step S608 and the subsequent steps. For example, in the case where the tracking target object is occluded in the immediately previous frame, the first estimation unit 406 may advance the processing to step S608 and the subsequent steps.

In step S604, the first estimation unit 406 determines the tracking target. As a method for determining the tracking target, for example, the first estimation unit 406 associates, with the tracking target, the object candidate a distance of which from the centroid coordinates of the tracking target determined in the immediately previous frame is the threshold value or less, and the matching cost thereof with the image feature of the template of the tracking target set in step S503 is lowest. Further, the first estimation unit 406 performs association on other object candidates in a similar manner.

In the case of the image 702 in FIG. 7B, for example, the first estimation unit 406 performs template matching of the template of the first object 710, which is the tracking target in the immediately previous frame, with each of the object candidate 716 and the object candidate 717 in the current frame. Then, the first estimation unit 406 determines a combination with the lowest matching cost as the tracking target in the image 702.

In the present exemplary embodiment, assume that the combination of the first object 710 and the object candidate 716 has the lowest matching cost. In addition to the matching cost, the first estimation unit 406 may add a penalty to a matching cost value as the distance from the tracking target in the immediately previous frame increases.

In step S605, the first estimation unit 406 acquires the tracking information for the immediately previous N frames. In the present exemplary embodiment, the tracking information indicates area information (coordinates, width, and height) and an object identification (ID) of the tracking target, and area information (coordinates, width, and height) and an object ID of another object detected as the object candidate and different from the tracking target. Hereinbelow, descriptions are provided by adding object IDs in such a manner that the tracking target object ID is “0”, and object IDs of other objects are 1, . . . , n (n≥1). In the case of FIG. 7A, the descriptions are provided assuming that the first object 710 has an object ID=0, and the second object 711 has an object ID=1.

In step S606, the first estimation unit 406 acquires the depth information for the immediately previous N frames. Drawings on a lower side of FIGS. 7A to 7D respectively illustrate defocus maps 705 to 708 obtained by dividing an area of each of the images 701, 702, 703, and 704 into rectangles in a lattice manner and mapping the defocus amounts corresponding to the respective lattice areas as examples of the depth information. Further, a gray scale color bar 709 corresponds to defocus amount values. Each defocus map expresses that the darker the color is, the farther (on the back side) the object is located, and the lighter the color is, the nearer (on the front side) the object is located, with the density of 0δF as a reference. An actual defocus map has a defocus amount also in the background area, but in the defocus maps 705 to 708 in FIGS. 7A to 7D, only the defocus amount in each of the object areas (person area) is cut out to make the description easier to understand.

For example, when the first object 710 that is the tracking target is in a focused state in the image 701 in FIG. 7A, since the object area 712 of the first object 710 corresponds to an area 726 in the defocus map 705, it can be read that the defocus amount d indicates a value d=0.

On the other hand, since an area 713 of the second object 711 corresponds to an area 727 in the defocus map 705, it can be read that the defocus amount d indicates d>0. In other words, it can be read that the second object 711 is located farther (on the back side) than the first object 710.

In step S607, the first estimation unit 406 acquires the time-series shift of the defocus amount for each of the first object and the second object to estimate the front-back relationship between the first object and the second object. Hereinbelow, in the image 702 in FIG. 7B, the first estimation unit 406 acquires a time-series list (queue) of the defocus amounts at the coordinates of the object areas in three immediately previous frames for the first object (object ID=0) and the second object (object ID=1). Then, the first estimation unit 406 estimates the front-back relationship between the first object and the second object.

In the present exemplary embodiment, the first estimation unit 406 estimates the front-back relationship using a plurality of defocus amounts including the defocus amount of the immediately previous frame arranged in time-series because the defocus amount includes sensor noise at the time of measurement and, if only the defocus amount of the current frame is used, the front-back relationship may be erroneously detected. In this way, the robustness can be improved.

First, assume that the time-series list of the defocus amounts for the first object (object ID=0) is [0Fδ, 0Fδ, 0Fδ]. Further, assume that the time-series list of the defocus amounts for the second object (object ID=1) is [0Fδ, 1Fδ, 2Fδ]. In this case, the first estimation unit 406 acquires [0Fδ, −1Fδ, −2Fδ] as a time-series list of differences (depth differences) of the defocus amounts for the second object (object ID=1) with respect to the defocus amount for the first object (object ID=0).

In estimating the front-back relationship, since it is sufficient in many cases if the sign of a depth difference is obtained, and the list may be divided by the product [Fδ] of the aperture F value and the permissible circle of confusion diameter δ in the imaging optical system. Thus, in the present exemplary embodiment, the front-back relationship is estimated using a list obtained by dividing a list of the depth difference by the product [Fδ].

An example of a method for estimating the front-back relationship will be described. For example, the first estimation unit 406 estimates that the first object (object ID=0) is located on the back side of the second object (object ID=1) in a case where all the signs of the depth differences of M immediately previous frames are the positive signs. Further, for example, the first estimation unit 406 estimates that the first object (object ID=0) is located on the front side of the second object (object ID=1) in a case where all the signs of the depth differences of the M immediately previous frames are the negative signs.

At this time, assume a case where the time-series list of the depth differences [0, −1, −2] is obtained, and two immediately previous frames are used. In this case, since all the depth differences between the first object (object ID=0) and the second object (object ID=1) have the negative signs, the first estimation unit 406 estimates that the first object (object ID=0) is located on the front side of the second object (object ID=1). On the other hand, in a case where three immediately previous frames are used, three consecutive frames do not have the same signs. Thus, the first estimation unit 406 estimates that the front-back relationship between the first object (object ID=0) and the second object (object ID=1) is unknown. The first estimation unit 406 records an estimation result of the front-back relationship with respect to the second object (object ID=1) in the memory 104. In a case where two or more other objects different from the tracking target detected as the object candidates are present, the first estimation unit 406 acquires a time-series list of the depth differences for each of the other objects (object ID=1, . . . , n), and estimates the front-back relationship between the tracking target and each of the other objects.

Another example of the method for estimating the front-back relationship will be described. For example, the first estimation unit 406 calculates a weighted average value of the depth differences of the M immediately previous frames, and determines whether a calculated value is negative (positive) and whether the absolute value is greater than or equal to a predetermined value. In a case where the weighted average value is negative (positive) and the absolute value is greater than or equal to the predetermined value, the first estimation unit 406 estimates that the first object (object ID=0) is located on the front side (back side) of the second object (object ID=1). On the other hand, in a case where the absolute value of the weighted average is less than the predetermined value, the first estimation unit 406 estimates that the front-back relationship between the first object (object ID=0) and the second object (object ID=1) is unknown.

In this case, for example, in a case where immediately previous three frames are used, a weight w is set such that weight values decrease more for earlier frames, such as w=[0.1, 0.3, 0.6]. Further, for example, the first estimation unit 406 estimates that the value at which the front-back relationship is determined as unknown is 0.5. In this case, the first estimation unit 406 estimates that the tracking target is located on the back side of the second object (object ID=1) in a case where the absolute value of the weighted average is greater than or equal to 0.5 and the weighted average has the positive sign, and the tracking target is located on the front side of the second object (object ID=1) in a case where the absolute value of the weighted average is greater than or equal to 0.5 and the weighted average has the negative sign.

In the present exemplary embodiment, in the case where [0, −1, −2] is obtained as the time-series list of the depth differences as described above, the weighted average value of the depth differences for the three immediately previous frames is calculated by taking an inner product using the weight w as described below.

$$0 \times 0.1 + ( - 1 ) \times 0.3 + ( - 2 ) \times 0.6 = - 1.5$$

As the absolute value of the calculated value is more than 0.5, the first estimation unit 406 estimates that the first object (object ID=0) is located in front of the second object (object ID=1).

Further, another example of the method for estimating the front-back relationship will be described. For example, the first estimation unit 406 may estimate the front-back relationship in a case where a moving average value is calculated for depth difference values and when the moving average value is negative (positive) and the absolute value of the moving average value of the depth difference values is greater than or equal to a predetermined value. The depth differences, of which the moving average value is calculated, is expressed by the following formula (1).

$$\overline{{Δ}_{t}} = {αΔ}_{t} + ( 1 - a ) \overline{{Δ}_{t - 1}} \qquad ( 1 )$$

Δₜ=depth difference at time t
α=weight coefficient for moving average
Δ̅ₜ=moving-averaged depth difference

As described above, the first estimation unit 406 estimates the front-back relationship between the first object and the second object in the case where the first estimation unit 406 determines that the tracking target object is in the state of neither being occluded nor being located near (being overlapped with) another object candidate in the immediately previous frame. Then, the processing proceeds to step S507.

Next, a processing flow performed when the processing proceeds to step S608 will be described.

In step S608, the first estimation unit 406 acquires, from the memory 104, a most recent estimation result of the front-back relationship between the first object and the second object. The estimation result of the front-back relationship is calculated by the processing in steps S604 to S607 described above and stored in the memory 104. In the image 703 in FIG. 7C, assume that an object candidate 720 and an object candidate 721 have been determined to overlap each other. In this frame, if the tracking target object is occluded, because an estimation of the front-back relationship is difficult, the first estimation unit 406 acquires the estimation result of the front-back relationship in the image 702 in the immediately previous frame.

In step S609, the first estimation unit 406 performs first occlusion determination processing to determine whether the tracking target object is occluded by another object for two or more object candidates overlapping each other in the current frame, using the estimation result of the front-back relationship acquired in step S608. Then, the processing proceeds to step S507.

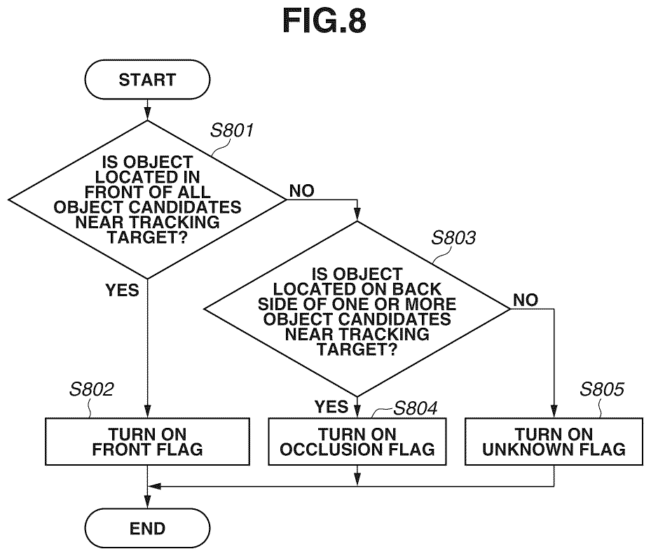

FIG. 8 is a flowchart illustrating an example of the first occlusion determination processing performed in step S609.

In step S801, in a case where the first estimation unit 406 estimates that the first object is located in front of all the other objects different from the tracking target in the most recent estimation result of the front-back relationship between the first object and the second object (YES in step S801), the processing proceeds to step S802. Otherwise (NO in step S801), the processing proceeds to step S803.

In step S802, the first estimation unit 406 turns a front flag ON.

In step S803, the first estimation unit 406 determines whether the first object is located on the back side of one or more other objects different from the tracking target in the most recent estimation result of the front-back relationship between the first object and the second object. In a case where the first estimation unit 406 determines that the first object is located on the back side of one or more other objects different from the tracking target in the most recent estimation result of the front-back relationship between the first object and the second object (YES in step S803), the processing proceeds to step S804. Otherwise (NO is step S803), the processing proceeds to step S805.

In step S804, the first estimation unit 406 turns ON an occlusion flag.

In step S805, the first estimation unit 406 turns ON an unknown flag indicating whether the first object is occluded is unknown.

In the image 703 in FIG. 7C, in the case where the first estimation unit 406 has estimated that the first object 718 is in front of the second object 719 in the estimation of the front-back relationship in the image 702 in the immediately previous frame as described above, the first estimation unit 406 turns ON the front flag. As described above, the first occlusion determination processing in step S609 is performed.

Now, the description returns to the description of step S507 in FIG. 5.

In step S507, the determination unit 407 determines the tracking target. In a case where the first estimation unit 406 determines that the tracking target object is not occluded and does not overlap the other object candidates in the immediately previous frame in step S603, the tracking target has already been determined in step S604.

On the other hand, in a case where the first occlusion determination processing in step S609 is executed and the front flag is turned ON, similar to step S604, the determination unit 407 calculates the matching cost using the image feature, and determines the matched object candidate as the tracking target.

On the other hand, in a case where the first occlusion determination processing in step S609 is executed and the occlusion flag is turned ON, since the first estimation unit 406 can determine that the tracking target object is occluded, the determination unit 407 performs control so as not to set an occluded area as the tracking target. In other words, the determination unit 407 does not determine the tracking target from among the object candidates detected in step S504. In this way, the system control unit 102 performs control so as not to focus on the similar object occluding the tracking target. Processing performed in a case where the first occlusion determination processing in step S609 has been executed and the unknown flag is turned ON will be described in a second exemplary embodiment.

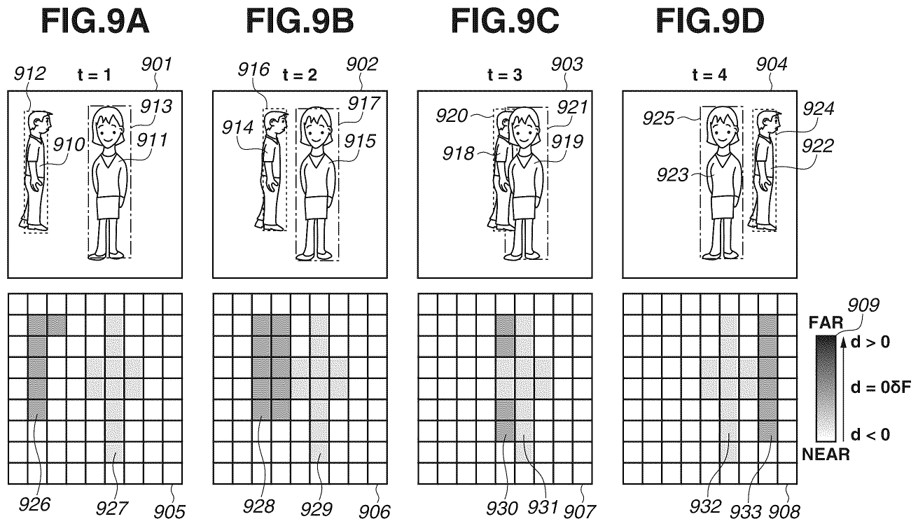

FIGS. 9A to 9D illustrate another example of a scene in which the tracking target object moves near a similar object from left to right in a different manner from that in FIGS. 7A to 7D. In FIGS. 9A to 9D, the tracking target object passes behind another object. The upper figures in FIGS. 9A to 9D illustrate consecutive frames. The lower figures in FIGS. 9A to 9D illustrate pieces of depth information corresponding to the respective frames illustrated in the upper figures. Assume that an object area 912 is set as the tracking target in an image 901 in FIG. 9A. First objects 910, 914, 918, and 922 are the objects of a same person detected as the object candidates in step S504. In this case, the first object is an object to be the tracking target. Second objects 911, 915, 919, and 923 are the objects of a same person detected as the object candidates in step S504. Assume that the second object is located in front of the first object in the image in each of the frames. In this case, in an image 903 in FIG. 9C, assume that the first estimation unit 406 determines that an object candidate 920 and an object candidate 921 overlap each other in step S603. In this case, in step S608, the first estimation unit 406 acquires the estimation result of the front-back relationship between the first object 914 and the second object 915 in an image 902 in the immediately previous frame. In this case, assume that the first object is estimated to be located on the back side of the second object.

In a case where the first estimation unit 406 estimates that the first object is located on the back side, the occlusion flag is turned ON by the processing performed in steps S803 and S804. In the case where the occlusion flag is ON, the system control unit 102 controls the lens driving so as not to focus on the object candidate 921. Accordingly, even in a case where the first object 922 passes behind the second object 923 and appears again in an image 904 in the next frame, it is possible to continue focusing on the first object 922.

In the case where the tracking is once interrupted due to the tracking target object being occluded as described above, when the overlapping with the second object 923 is removed as in the case of the first object 922 in the image 904, the system control unit 102 performs tracking recovery processing. More specifically, the system control unit 102 sets, as the tracking target, the object candidate located near the occluded object candidate and with the defocus amount close to 0 (e.g., a setting value of the defocus amount is a predetermined value or less), and starts the tracking again.

According to the present exemplary embodiment, in the scene in which the tracking target object moves near the similar object, it is possible to suppress erroneous tracking by estimating a positional relationship in the depth direction between the tracking target object and the other object. In the tracking method using the image feature, in the case where the similar object passes in front of the tracking target object, the occluding object in front may be focused on, but it is possible to suppress such erroneous tracking by using depth distances of the objects arranged in time series.

In the second exemplary embodiment, a description is given of a method for estimating an occlusion state of the tracking target even in a case where a depth difference between objects is small and whether the tracking target object is occluded by the other object is unknown as in a case where the unknown flag is turned ON by the first occlusion determination processing in step S609. Note that contents overlapping the contents in the first exemplary embodiment are not described.

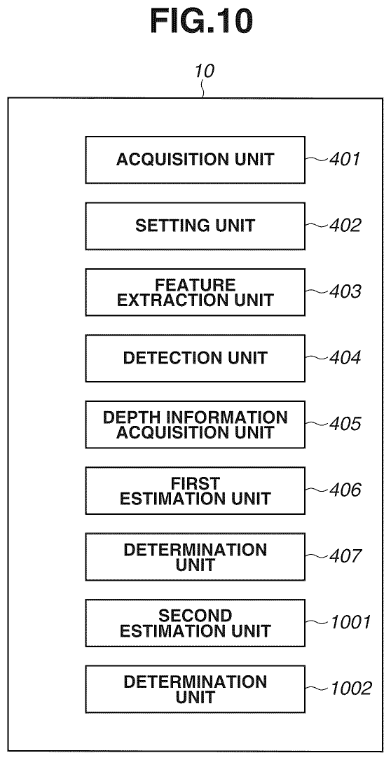

FIG. 10 illustrates an example of a functional configuration of an image capturing apparatus 10 according to the present exemplary embodiment. The image capturing apparatus 10 includes a second estimation unit 1001 and a determination unit 1002 in addition to the functional units illustrated in FIG. 3.

The second estimation unit 1001 estimates an occlusion state indicating whether a tracking target object is occluded by another object using an image feature of an object candidate detected by the detection unit 404.

The determination unit 1002 determines whether the tracking target object is occluded by another object using an estimation result of the first estimation unit 406 and an estimation result of the second estimation unit 1001.

The determination unit 407 according to the present exemplary embodiment determines the tracking target from among the object candidates detected by the detection unit 404 based on the estimation result of the first estimation unit 406 and the estimation result of the second estimation unit 1001.

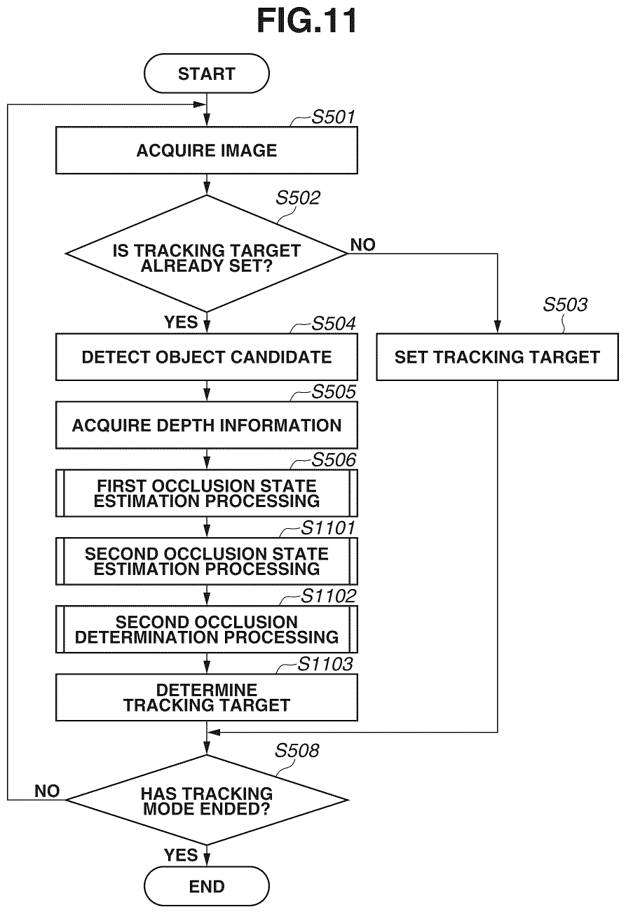

FIG. 11 is a flowchart illustrating tracking processing performed by the image capturing apparatus 10 according to the present exemplary embodiment. The flowchart in FIG. 11 is different from the flowchart in FIG. 5 in that processing in steps S1101 to S1103 is performed instead of the processing in step S507. A description will be provided focusing on the processing in steps S1101 to S1103.

In step S1101, the second estimation unit 1001 performs second occlusion state estimation processing using the image feature. The second occlusion state estimation processing in step S1101 may be executed in a case where the unknown flag is turned ON in the first occlusion state estimation processing in step S506, and may not be executed in a case where any one of the front flag and the occlusion flag is turned ON in the first occlusion state estimation processing in step S506. In the case where any one of the front flag and the occlusion flag is turned ON in the first occlusion state estimation processing in step S506, the processing similar to that in the first exemplary embodiment is performed instead of the processing in steps S1101 to S1103. More specifically, the system control unit 102 performs control so as to determine and track the matched object candidate as the tracking target in a case where the front flag is ON, and not to track the detected object candidate as the tracking target in the case where the occlusion flag is ON.

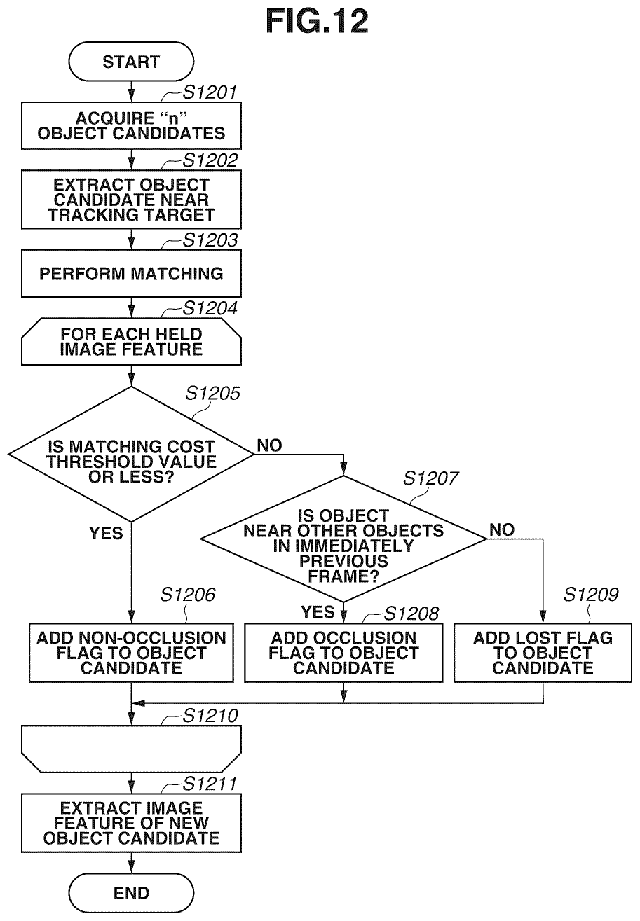

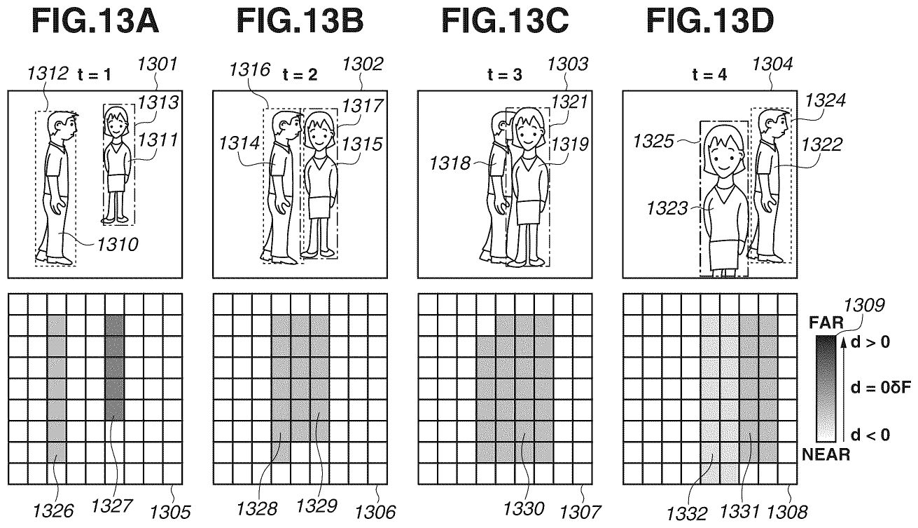

FIG. 12 is a flowchart illustrating the second occlusion state estimation processing performed in step S1101. FIGS. 13A to 13D illustrate an example of a scene in which a tracking target object moves near a similar object from left to right. The upper figures in FIGS. 13A to 13D illustrate consecutive frames. The lower figures in FIGS. 13A to 13D illustrate pieces of depth information corresponding to the respective frames illustrated in the upper figures. Assume that an object area 1312 is set as the tracking target in an image 1301 in FIG. 13A. First objects 1310, 1314, 1318, and 1322 are the objects of a same person detected as the object candidates in step S504. Second objects 1311, 1315, 1319, and 1323 are the objects of a same person detected as the object candidates in step S504.

In step S1201, the second estimation unit 1001 acquires object candidates by processing similar to that in step S601. In this case, assume that the number of acquired object candidates is “n”. In the example in FIGS. 13A to 13D, in the images 1301, 1302, and 1304, n=2, and in an image 1303, due to an influence of the first object 1318 being occluded by the second object 1319, the first object 1318 is not detected as the object candidate, and thus n=1.

In step S1202, the second estimation unit 1001 extracts an object candidate(s) near the tracking target object by processing similar to that in step S602. In a case where the tracking target object is not detected because the tracking target object is occluded or the like, the object candidate is extracted by using the coordinates in the immediately previous frame in which the tracking target object has been detected.

In step S1203, the second estimation unit 1001 performs matching by calculating the matching cost using the image feature. More specifically, the second estimation unit 1001 acquires the image feature (template) of each of the object candidates detected in each of the images of immediately previous N frames, and performs correlation calculation with the object candidate in the image in the current frame to calculate a matching cost for each template. Correction processing may be performed in calculating the matching cost in consideration of the coordinates and the size of each of the object candidates in the image in the immediately previous frame.

For example, the second estimation unit 1001 searches for a set of the object candidate and the matching cost such that the total of matching costs of n object candidates is minimized, associates the image feature with the object candidate, and performs tracking of each of the objects. In a case where no object that corresponds to the image feature is present, the second estimation unit 1001 sets the matching cost value of the image feature to a value greater than a threshold value to be set in step S1205.

The processing performed in steps S1204 to S1210 is processing to determine whether the object corresponding to the image feature is occluded in the current frame, for the image feature acquired in each of the images in the immediately previous N frames.

In step S1205, the second estimation unit 1001 determines whether the matching cost of the object candidate associated with the image feature is a threshold value or less. In a case where the matching cost is the threshold value or less (YES in step S1205), the processing proceeds to step S1206. In a case where the matching cost is the threshold value or more (NO in step S1205), the processing proceeds to step S1207.

In step S1206, the second estimation unit 1001 estimates that tracking of the object corresponding to the image feature is successfully performed, and adds a non-occlusion flag to the object corresponding to the image feature. For example, in the image 1302 in the current frame, the second estimation unit 1001 performs matching with object candidates 1316 and 1317 in the image 1302 using the image feature of the first object 1310 in the image 1301 in the immediately previous frame. As a result, in a case where the matching cost with the object candidate 1316 is the threshold value or less, the second estimation unit 1001 estimates that the object corresponding to the image feature of the first object 1310 is not occluded, and turns ON the non-occlusion flag of the first object 1310.

In step S1207, the second estimation unit 1001 acquires information indicating whether the object associated with the image feature has been located near (overlapped with) the other object in the immediately previous frame. In a case where these objects have been located near each other in the immediately previous frame (YES in step S1207), the processing proceeds to step S1208. Otherwise (NO in step S1207), the processing proceeds to step S1209.

In step S1208, the second estimation unit 1001 estimates that the object corresponding to the image feature is lost and is occluded by the other object that has been near previously, and adds the occlusion flag to the object corresponding to the image feature. For example, in the image 1303 in the current frame, assume that the object candidate matching the image feature of the first object 1314 in the image 1302 in the immediately previous frame is not found. At this time, since the first object 1314 is located near the second object 1315 in the image 1302, the second estimation unit 1001 estimates that the object corresponding to the image feature of the first object 1314 is occluded, and turns ON the occlusion flag of the first object 1314.

In step S1209, the second estimation unit 1001 estimates that the object corresponding to the image feature is lost, and adds a lost flag to the object candidate associated with the image feature.

In step S1211, the second estimation unit 1001 extracts the image feature of the object candidate that has not been associated in the matching in step S1203 as a new object candidate not present in the previous frames, and holds it.

By the occlusion state estimation processing illustrated in the flowchart in FIG. 12, the second estimation unit 1001 estimates the occlusion state indicating whether the tracking target object is occluded by the other object, using the image feature.

Now, the description returns to the flowchart in FIG. 11.

In step S1102, the determination unit 1002 performs second occlusion determination processing of determining whether the tracking target object is in the occlusion state, the non-occlusion state, or the lost-state using the estimation result of the occlusion state in step S506 and the estimation result of the occlusion state in step S1101.

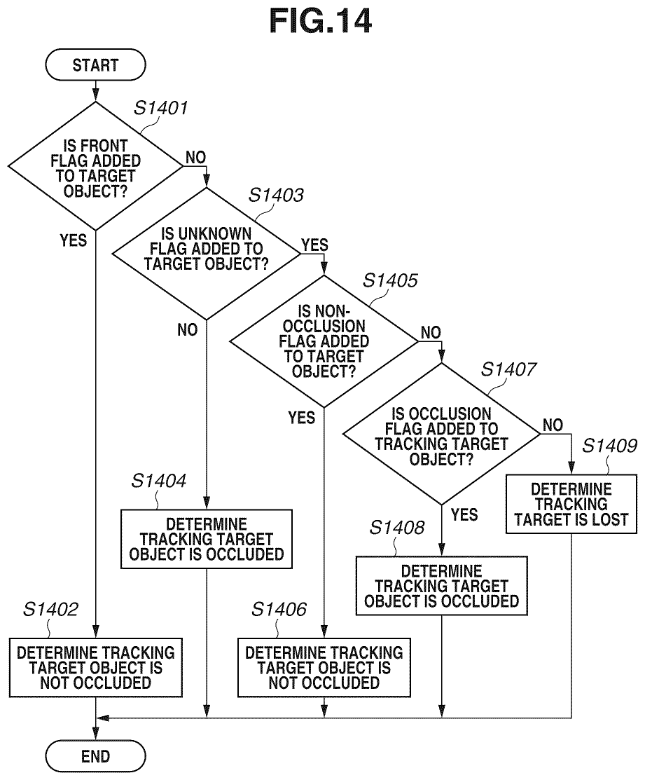

FIG. 14 is a flowchart illustrating an example of the second occlusion determination processing performed in step S1102.

In step S1401, the determination unit 1002 determines whether the front flag is turned ON from processing result of the first occlusion determination processing. In a case where the front flag is ON (YES in step S1401), the processing proceeds to step S1402. Otherwise (NO in step S1401), the processing proceeds to step S1403.

In step S1402, the determination unit 1002 determines that the tracking target object is not occluded.

In step S1403, the determination unit 1002 determines whether the unknown flag is turned ON from the processing result of the first occlusion determination processing. In a case where the unknown flag is turned ON (YES in step S1403), the processing proceeds to step S1405. Otherwise (NO in step S1403), the processing proceeds to step S1404.

In step S1404, the determination unit 1002 determines that the tracking target object is located on the back side of the other object and is occluded.

In the case where the processing proceeds to step S1405, i.e., in the case where the determination of whether the tracking target object is occluded is difficult from the depth information, the determination unit 1002 determines whether the non-occlusion flag is turned ON in step S1206 from the estimation result of the occlusion state estimated in step S1101. In a case where the non-occlusion flag of the tracking target object (first object) is turned ON (YES in step S1405), the processing proceeds to step S1406. Otherwise (NO in step S1405), the processing proceeds to step S1407.

In step S1406, the determination unit 1002 determines that the tracking target object is not occluded.

In step S1407, the determination unit 1002 determines whether the occlusion flag is added to the tracking target object from the estimation result of the occlusion state in step S1101. In a case where the occlusion flag of the tracking target object (first object) is turned ON (YES in step S1407), the processing proceeds to step S1408. Otherwise (NO in step S1407), the processing proceeds to step S1409.

In step S1408, the determination unit 1002 determines that the tracking target object is located on the back side of the other object and is occluded.

In step S1409, the determination unit 1002 determines that the tracking target is lost.

After the second occlusion determination processing is performed in step S1102, the processing proceeds to step S1103.

In step S1103, the determination unit 407 determines the tracking target. In the case where the determination unit 1002 determines that the tracking target object is not occluded by the second occlusion determination processing performed in step S1102, the determination unit 407 determines the object candidate corresponding to the image feature of the tracking target object as the tracking target. Further, in the case where the determination unit 1002 determines that the tracking target object is occluded by the second occlusion determination processing performed in step S1102, the determination unit 407 performs control not to set the detected object candidate as the tracking target.

According to the present exemplary embodiment, in the scene in which the tracking target object moves near the similar object, it is possible to suppress erroneous tracking by estimating a positional relationship in the depth direction between the tracking target object and the other object. In addition to the effect of the first exemplary embodiment, accuracy of tracking can be improved by performing complementation by a tracking method using an image feature in the case where it is difficult to determine the distance difference in the depth direction between the objects.

In a third exemplary embodiment, a description is provided of a method for using information related to an operation state of the image capturing apparatus 10 together with the depth information at the image capturing time. With a single-lens reflex camera that is an example of the image capturing apparatus 10, the operation state of the image capturing apparatus 10 rapidly changes by a photographer performing zooming, focusing, framing, or the like while performing image capturing. Such a rapid change of the operation state may sometimes affect accuracy of the depth information acquired from the image capturing apparatus 10. Thus, in the present exemplary embodiment, a description is provided of the method for performing the tracking processing using also the information related to the operation state of the image capturing apparatus 10.

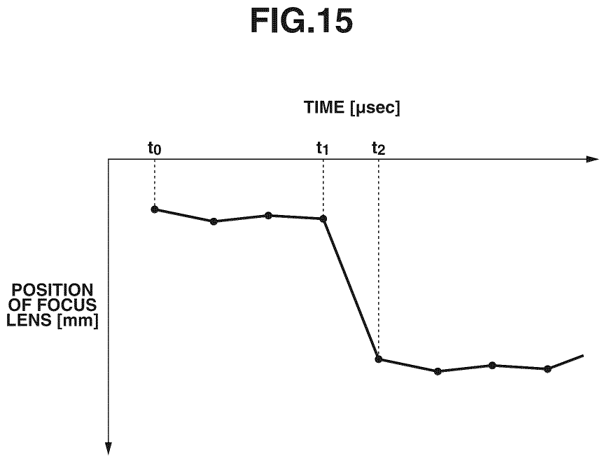

In the present exemplary embodiment, as an example of the operation state of the image capturing apparatus 10, a driving state of the focus lens in the imaging lens 201 will be described. FIG. 15 is a graph illustrating a time-series shift of the position of the focus lens in the imaging lens 201 in an optical axis direction. The horizontal axis represents time, and the vertical axis represent the position of the focus lens. Assume that the image capturing apparatus 10 starts capturing an image of the object from a time t0 in the tracking mode. Between the time t0 to a time t1, the position of the focus lens remains almost unchanged, and a lens driving amount is small. Between the time t1 and a time t2, the position of the focus lens largely changes, and the lens driving amount is large. As described above, since the defocus amount is an amount based on a deviation on the image forming plane (imaging plane 300), the defocus amount is a relative value to the lens position. For this reason, the defocus amounts before and after the focus lens has largely moved, such as the defocus amount at the time t2 and the defocus amount at the time t1, cannot be simply compared.

Thus, the system control unit 102 may acquire the lens drive information related to the driving amount of the focus lens in the imaging lens 201 from the lens control unit 205, and may correct the weight w for the front-back relationship estimation processing described in the first exemplary embodiment based on the lens drive information. In this case, in a case where the lens driving amount is large, for example, the first estimation unit 406 can reduce an influence of the depth information with a low reliability by setting the weight for the frame small.

For example, in a case where three immediately previous frames are used, the weight w is set as w=[0.1, 0.3, 0.6]. In this case, when the lens driving amount is a predetermined value or less, the first estimation unit 406 may estimate the front-back relationship by calculating a weighted average (inner product) of the time-series list of the depth differences multiplied by the weights w. At this time, in a case where the lens driving amount is larger than the predetermined value in a frame two before the current frame during tracking, the first estimation unit 406 may set the second value in the list of the weights w to be smaller than the original value. In this way, it is possible to estimate the front-back relationship more stably. In a case where the weight w is to be set small, the weight w may be made smaller by being multiplied by a predetermined coefficient, or the weight w may be made smaller as the lens driving amount is larger.

Further, the first estimation unit 406 may adjust, depending on the lens driving amount, the number of elements (frames) in the time-series list of the defocus amounts in the front-back relationship estimation processing described in the first exemplary embodiment. For example, a case is considered where the first estimation unit 406 determines the front-back relationship between the first object and the second object such that the first object (tracking target) is located on the back side if the signs of the depth differences of immediately previous M consecutive frames are all positive, and the first object (tracking target) is located on the front side if the signs thereof are all negative. At this time, for example, in a case where the lens driving amount is large, the number (M) of frames to be referred to is increased. Accordingly, since it is determined whether the first object is located on the back side or the front side at a longer time interval, a risk of erroneous tracking due to the erroneous depth information can be reduced.

According to the third exemplary embodiment described above, even in the case where the operation state of the image capturing apparatus largely changes between frames, it is possible to achieve stable tracking by reducing the influence of the depth information with a low reliability.

Although the present disclosure has been described in detail based on the exemplary embodiments thereof, the present disclosure is not limited to these specific exemplary embodiments, and various modes within a scope not departing from the gist of the present disclosure are also included in the present disclosure. Furthermore, each of the above-described exemplary embodiments merely represents one exemplary embodiment of the present disclosure, and the exemplary embodiments can be combined as appropriate.

According to the present disclosure, it is possible to track a tracking target object accurately.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-102814, filed Jun. 26, 2024, which is hereby incorporated by reference herein in its entirety.

What is claimed is:

1. An information processing apparatus comprising at least one processor configured to function as:
an acquisition unit configured to acquire images captured in time series and distance information in a depth direction on a plurality of areas in each of the images;
a detection unit configured to detect a candidate area of an object to be a tracking target from each of the images based on an image feature of each of the images;
an estimation unit configured to estimate an occlusion state indicating whether the object to be the tracking target is occluded by another object different from the tracking target for the candidate area detected from each of the images based on time-series data of the distance information; and
a determination unit configured to determine the candidate area of the object to be the tracking target from the candidate area detected from each of the images based on an estimation result of the occlusion state.

2. The information processing apparatus according to claim 1,
wherein the estimation unit estimates, based on the time-series data of the distance information for each of the candidate areas associated with a first object being the object to be the tracking target and for each of the candidate areas associated with a second object being different from the first object, a front-back relationship between the first object and the second object in the depth direction, and
wherein the estimation unit determines the occlusion state of the first object based on an estimation result of the front-back relationship.

3. The information processing apparatus according to claim 2,
wherein the acquisition unit sequentially acquires frames of a moving image and acquires the distance information for each of the frames,
wherein the detection unit detects the candidate area for each of the frames, and
wherein the estimation unit estimates the occlusion state for each of the frames.

4. The information processing apparatus according to claim 3, wherein, in a case where the occlusion state in an immediately previous frame indicates that the object to be the tracking target is occluded, the estimation unit determines the occlusion state in a current frame based on the estimation result of the front-back relationship.

5. The information processing apparatus according to claim 3,
wherein the estimation unit determines the occlusion state in a current frame based on the estimation result of the front-back relationship in a case where at least a portion of the candidate area in an immediately previous frame or a current frame overlaps another candidate area in the frame, and
wherein, in a case where the candidate area in the immediately previous frame or the current frame does not overlap the other candidate area in the frame, the estimation unit determines the candidate area to be associated with the first object from the candidate area in the current frame by performing matching using the image features of the candidate areas respectively associated with the first object and the second object in the immediately previous frame.

6. The information processing apparatus according to claim 3, wherein the estimation unit estimates the front-back relationship based on a difference between pieces of the distance information respectively corresponding to the candidate area associated with the first object and the candidate area associated with the second object in each of a plurality of frames including an immediately previous frame arranged in time series.

7. The information processing apparatus according to claim 6, wherein the estimation unit estimates the front-back relationship in a case where differences between the pieces of the distance information have a same sign consecutively in a predetermined number of frames.

8. The information processing apparatus according to claim 6, wherein the estimation unit estimates the front-back relationship in a case where an absolute value of an average of the differences between pieces of the distance information of a predetermined number of frames is greater than or equal to a predetermined value.

9. The information processing apparatus according to claim 1, wherein the estimation unit performs weighting on the time-series data of the distance information such that a weight decreases more for earlier data.

10. The information processing apparatus according to claim 6, wherein the estimation unit calculates a moving average of the differences between the pieces of the distance information.

11. The information processing apparatus according to claim 2,
wherein the estimation unit extracts a plurality of candidate areas overlapping the candidate area associated with the first object, and
wherein the estimation unit determines the occlusion state of the first object by estimating the front-back relationship for each combination of the candidate area associated with the first object and the extracted plurality of candidate areas.

12. The information processing apparatus according to claim 3, wherein the estimation unit determines the occlusion state of the first object by performing matching of the candidate area in a current frame using the image feature of the candidate area associated with the first object in the immediately previous frame.

13. The information processing apparatus according to claim 12, wherein the estimation unit determines that the first object is not occluded in a case where a matching cost obtained as a result of the matching is a threshold value or less.

14. The information processing apparatus according to claim 12, wherein the estimation unit determines that the first object is occluded in a case where a matching cost obtained as a result of the matching is larger than a threshold value and another candidate area is present near the candidate area associated with the first object.

15. The information processing apparatus according to claim 12,
wherein the estimation unit determines the occlusion state of the first object based on the estimation result of the front-back relationship in a case where the estimation unit has been able to estimate the front-back relationship based on the time-series data of the distance information, and
wherein the estimation unit determines the occlusion state of the first object by performing matching of the candidate area in the current frame using the image feature of the candidate area associated with the first object in the immediately previous frame in a case where the estimation unit has not been able to estimate the front-back relationship based on the time-series data of the distance information.

16. The information processing apparatus according to claim 1, wherein the estimation unit corrects the time-series data of the distance information based on an operation state of an image capturing apparatus that has captured the images.

17. The information processing apparatus according to claim 16, wherein the estimation unit acquires a lens driving amount from the image capturing apparatus and corrects the time-series data of the distance information based on the lens driving amount.

18. The information processing apparatus according to claim 1, further comprising a control unit configured to control lens driving to focus on the candidate area determined by the determination unit,
wherein the control unit controls the lens driving not to focus on the candidate area in a case where the occlusion state indicates that the object to be the tracking target is occluded.

19. The information processing apparatus according to claim 1, wherein the acquisition unit acquires a defocus amount detected from each focus detection area on an imaging plane as the distance information.

20. An image capturing apparatus comprising at least one processor configured to function as:
an acquisition unit configured to acquire images captured in time series and distance information in a depth direction on a plurality of areas in each of the images;
a detection unit configured to detect a candidate area of an object to be a tracking target from each of the images based on an image feature of each of the images;
an estimation unit configured to estimate an occlusion state indicating whether the object to be the tracking target is occluded by another object different from the tracking target for the candidate area detected from each of the images based on time-series data of the distance information; and
a determination unit configured to determine the candidate area of the object to be the tracking target from the candidate area detected from each of the images based on an estimation result of the occlusion state.

21. An information processing method comprising:
acquiring images captured in time series and distance information in a depth direction on a plurality of areas in each of the images;
detecting a candidate area of an object to be a tracking target from each of the images based on an image feature of each of the images;
estimating an occlusion state indicating whether the object to be the tracking target is occluded by another object different from the tracking target for the candidate area detected from each of the images based on time-series data of the distance information; and
determining the candidate area of the object to be the tracking target from the candidate area detected from each of the images based on an estimation result of the occlusion state.

22. A non-transitory computer-readable storage medium storing a computer program including instructions for executing following processes:
acquiring images captured in time series and distance information in a depth direction on a plurality of areas in each of the images;
detecting a candidate area of an object to be a tracking target from each of the images based on an image feature of each of the images;
estimating an occlusion state indicating whether the object to be the tracking target is occluded by another object different from the tracking target for the candidate area detected from each of the images based on time-series data of the distance information; and
determining the candidate area of the object to be the tracking target from the candidate area detected from each of the images based on an estimation result of the occlusion state.
